(19) United States
(12) Patent Application Publication
(10) Pub. No.: US 2005/0264805 A1
(43) Pub. Date: Dec. 1, 2005

(54) Methods and apparatus for scanning small sample volumes

(75) Inventors: Evan F. Cromwell, Redwood City, CA (US); Steven C. Miller, Union City, CA (US); Christopher B. Shumate, Carlsbad, CA (US); Paul B. Comita, Menlo Park, CA (US)

Correspondence Address: BEYER WEAVER & THOMAS LLP, P.O. BOX 70250, OAKLAND, CA, 94612-0250, US

(73) Assignee: Blueshift Biotechnologies, Inc.

(21) Appl. No.: 11/055,244

(22) Filed: Feb. 9, 2005

Related U.S. Application Data
(60) Provisional application No. 60/543,409, filed on Feb. 9, 2004.

(51) Int. Cl. G01N 1/10

(52) U.S. Cl. 356/246

(57) ABSTRACT

Methods and apparatus for assaying biological materials employ multi-well substrates as described herein. The substrates include a plurality of wells, typically each of several nanoliters volume or smaller having consistent dimensions and formed in a rigid substrate such as a glass disk. Each well may be provided with a circumferential lip to minimize crosstalk between wells and/or facilitate optical location of the individual wells during interrogation. Samples are provided to the individual wells and assayed by an optical technique employing fluorescence, polarization, reflectance, or the like. A scanning laser system may be employed for this purpose. The substrate may rotate during the scan to allow consistent interrogation of the wells without stopping and starting the rotation. Multiple rotations may also be employed repeatedly interrogate the samples for use in a kinetic study, for example.

### CROSS-REFERENCE TO RELATED APPLICATIONS

The present application claims priority under 35 U.S.C. §119(e) from U.S. Provisional Patent Application No. 60/543,409 entitled “SUBSTRATE FOR ULTRAFAST SCANNING OF MINIATURIZED ASSAYS” filed Feb. 9, 2004, the entire disclosure of which is incorporated herein by reference for all purposes. The present application is also related to U.S. patent application Ser. No. 10/927,748 entitled “TIME DEPENDENT FLUORESCENCE MEASUREMENTS” filed on Aug. 26, 2004, and to U.S. patent application Ser. No. 10/928,484 entitled “MEASURING TIME DEPENDENT FLUORESCENCE” filed on Aug. 26, 2004, the entire disclosures of both of which are incorporated herein by reference for all purposes. The present application is also related to U.S. Provisional Patent Application No. 60/497,764, entitled “TIME DEPENDENT FLUORESCENCE MEASUREMENTS” filed Aug. 26, 2003, and to U.S. Provisional Patent Application No. 60/497,803, filed Aug. 26, 2003, the entire disclosures of both of which are incorporated herein by reference for all purposes.

### BACKGROUND

This invention relates to methods and apparatus for optically probing small volumes of biological materials and materials derived from biological materials.

The need to make drug discovery more efficient has given rise to technologies for increasing the number of drugs tested and the number of tests applied to determine the efficacy of a candidate drug. Conventionally, drug testing has been done in vials, dishes, and test tubes. More recently, the testing vessels have become miniaturized and grouped to form microarrays and multiwell plates. Associated mechanisms for transferring small volumes of sample material to these vessels have been developed and optimized to provide parallel delivery. Typically, the sample is analyzed by an optical probing technique such as fluorescence microscopy.

Miniaturization is an ever-present goal as it provides further conservation of reagents and allows more tests to be conducted in given region of a substrate. These benefits are especially noteworthy when only limited quantities of an experimental drug are available. Scarce quantities of such drug often need to be extensively tested over multiple cell lines and at multiple concentrations. Miniaturization can also result in significant cost savings when expensive samples or reagents are used, since much smaller volumes of the samples and reagents can be used.

Miniaturization is manifest as larger sample well densities and smaller sample volumes in the wells. This presents numerous technical challenges. For example, sample evaporation must be controlled to prevent significant changes in reagent concentration prior to and during assaying. Further, dispensing mechanisms must deliver precise quantities of sample rapidly and accurately to multiple closely spaced wells. Still further, imaging systems must rapidly and consistently interrogate the various miniature wells with sensitivity and noise discrimination.

The target substrate to which the sample material is transferred should be engineered to address these challenges. Ideally the substrate design provides the ability to capture the transferred sample materials in numerous localized areas on the substrate, to contain the sample without evaporation, and then to allow for efficient quantitative analysis by any number of techniques.

There is therefore a need for a target substrate that fulfills the requirements outlined above, whereby very small volumes and high densities of samples are contained on the target, and the reactions or content of the samples contained in the target can be rapidly and precisely analyzed.

### SUMMARY

Various aspects of the invention meet some or all of the challenges set forth above. In general, in one aspect, the invention provides methods and apparatus, including computer program products, implementing and using techniques for collecting optical data pertaining to one or more characteristics of one or more samples. The apparatus has a light source, a flat substrate, one or more illumination optical elements and one or more collection optical elements. The substrate has several sample wells, which each is configured to hold a sample volume no more than about 50 nanoliters. The illumination optical elements direct a light beam from the light source onto the sample wells. The collection optical elements collect light originating from within the sample wells and transmit the collected light to one or more detectors.

Advantageous implementations can include one or more of the following features. Each sample well can be configured to hold a sample volume at most about 10 nanoliters. Each sample well can be configured to hold a sample volume smaller than one nanoliter. A substrate cover can be provided that seals edges of the individual sample wells and that is designed to minimize evaporation of the samples in the sample wells and to prevent cross-talk between individual sample wells. The substrate can have a substantially circular shape. The substrate can have a hole in its center, which allows the substrate to be placed on a rotating spindle. The circular substrate can further include a reference mark for referencing all sample well locations on the substrate. The substrate can be a glass substrate. The perimeter of a sample well can be substantially circular and the diameter of the sample well can be significantly larger than a depth of the sample well. The diameter of a sample well can be in the range of about 1-100 micrometers. The depth of the sample well can be in the range of about 10 nanometers to 10 micrometers.

A perimeter of each sample well can be surrounded by a lip for preventing overflow of the sample well and cross talk between the sample wells. The lip can extend to a height corresponding to about one-tenth to one-third of the depth of the respective sample wells. Each sample well can contain a sample that is unique with respect to the samples in the other sample wells on the substrate. The sample contained in a sample well can include at least one of: a biological sample and material derived from a biological sample. The centers of the sample wells can be separated by no more than about 100 micrometers. The substrate can have a surface height variation of at most about 10 micrometers over a region of the substrate that is readable by the apparatus, and the region that is readable by the apparatus can have a roughness of at most about than 10 nanometers. The substrate areas between the sample wells can be coated with a hydrophobic material and the sample wells can be hydrophilic in order to improve the confinement of the sample volumes into the sample wells.

In general, in one aspect, the invention provides methods and apparatus, including computer program products, implementing and using techniques for collecting optical data pertaining to one or more characteristics of one or more samples. A flat substrate is provided that has several sample wells, which each is configured to hold a sample volume of at most about 50 nanoliters. One or more samples are dispensed into the sample wells. A light beam is directed from a light source onto the sample wells. Light originating from within the sample wells is collected and transmitted to one or more detectors. The signal from the detectors is analyzed to detect the one or more characteristics of the one or more samples.

Advantageous implementations can include one or more of the following features, some of which have been mentioned previously. A perimeter of each sample well can be surrounded by a lip for preventing overflow of the sample well and cross talk between the sample wells, and collecting light can include detecting when a focal point of a set of collection optical elements passes across an identifying feature on the substrate, and collecting light only when a focal point of a set of collection optical elements is located inside the perimeter defined by the lip. The identifying feature on the substrate can be a lip surrounding a sample well. The substrate can be substantially circular and collecting light can include rotating the circular substrate past a set of collection optical elements, and collecting light originating from within the sample well periodically each time the sample well rotates past the collection optical elements. The substrate can have a hole in the center and rotating can include rotating the circular substrate by means of a rotating spindle placed through the hole in the center of the substrate, past a set of collection optical elements.

In general, in one aspect, the invention provides a substrate for holding one or more biological samples in an apparatus for collecting optical data pertaining to one or more characteristics of the biological samples. The substrate includes a flat transparent glass substrate and a substrate cover. The glass slide has several sample wells formed therein and a set of fiducials against which the location of the sample wells can be determined by the apparatus. Each sample well holds a volume of a biological sample of at most about 50 nanoliters by one or more of: gravity, capillary action and surface tension and each sample well is surrounded by a lip arranged to prevent cross-talk between the sample wells. The substrate areas between the sample wells are coated with a hydrophobic material and the sample wells are hydrophilic in order to improve the confinement of the sample volumes into the sample wells. The substrate cover seals the edges of the individual sample wells and is designed to minimize evaporation of the biological samples in the sample wells.

The details of one or more embodiments of the invention are set forth in the accompanying drawings and the description below. Other features and advantages of the invention will be apparent from the description and drawings, and from the claims.

### DESCRIPTION OF DRAWINGS

FIG. 1 shows a schematic view of an apparatus for analyzing samples in accordance with one embodiment of the invention.

FIG. 2 shows an aerial view of a section of a substrate in accordance with one embodiment of the invention.

FIG. 3 shows an aerial view of a section of a substrate in accordance with another embodiment of the invention, where the arrangement of the wells provide encoding information.

FIG. 4A shows a vertical cross section of a single sample well formed in the substrate.

FIG. 4B shows a vertical cross section of a single sample well formed in the substrate.

FIG. 5A shows a vertical cross section of a single sample well with a liquid cover applied.

FIG. 5B shows a vertical cross section of a single sample well with a solid cover applied.

FIG. 6 shows a magnified schematic view of a substrate (102) with multiple sample wells (201) and part of the collection optical elements (119), with the openings of the sample wells (201) facing downwards.

FIG. 7 shows a magnified schematic view of a substrate (102) with multiple sample wells (201) and part of the collection optical elements (119), with the openings of the sample wells (201) facing upwards.

FIG. 8A shows a schematic view of a circular substrate (102) in accordance with one embodiment of the invention.

FIG. 8B shows a schematic view of the circular substrate (102) of FIG. 8A being interrogated by an apparatus in accordance with the invention.

Like reference symbols in the various drawings indicate like elements.

### DETAILED DESCRIPTION

Overview of the Analysis System

The invention provides an improved apparatus for interrogating and analyzing miniaturized samples, such as samples located in a number of small sample wells on a transparent substrate. An apparatus and methods suitable for analyzing such samples have been described in U.S. patent application Ser. No. 10/927,748 entitled “TIME DEPENDENT FLUORESCENCE MEASUREMENTS” and in U.S. patent application Ser. No. 10/928,484 entitled “MEASURING TIME DEPENDENT FLUORESCENCE,” the entire disclosures of both of which were incorporated herein by reference above.

In the described embodiment, the apparatus uses a scanning light source, which can be focused onto a substrate containing samples, with the ability to discriminate against background noise or signal, and makes use of image contrast mechanisms. The apparatus can be operated in several distinct modes or combinations thereof, depending on what type of sample data needs to be collected.

In a first mode, the output signal from the apparatus contains information such as the number of discrete positions in a cell or other object from which the fluorescent light originates, the relative location of the signal sources, and the color (e.g., wavelength or waveband) of the light emitted at various positions of the samples. In a second mode, a plane-polarized laser beam can be propagated through the optical system onto the samples, allowing interrogation of biological material with polarized light. The polarized nature of the excitation source allows for measurement of properties of biological materials where the characteristics of the anisotropy of the emission, or the time dependent nature of the relaxation of the polarization, can give rise to spatial or physical information about the biological moiety.

In a third mode, several laser beams can be propagated through the optical system onto the samples allowing interrogation of the biological material with different wavelengths of light or with the same wavelength at different times. In this mode the lasers can be pulsed simultaneously or with a fixed or variable delay between pulses. Delay between pulses allows for measurement of properties of biological materials in an excited state where the first laser pulse causes excitation of the biological moiety and the second or additional laser pulses interrogate that moiety in an excited state. The laser beams can be co-propagated so that they focus on the same sample during a scan or, alternatively, they can be propagated at some relative angle so that during a scan the laser beams sequentially move over the same sample.

In a fourth mode, a single modulated laser beam can be propagated through the optical system onto the sample allowing lifetime measurements of the fluorescence in the biological material. In a fifth mode, several detectors can be used in conjunction with one collection optics arrangement, which creates multiple confinement regions for analysis, the advantages of which will be described in further detail below. In a sixth mode, several collection optics arrangements can be used to provide improved confinement over a single collection optic with the unique geometry, or can be used to collect emission from the confined region with several characteristics which are uniquely specified to each collecting optics, the advantages which will be described below.

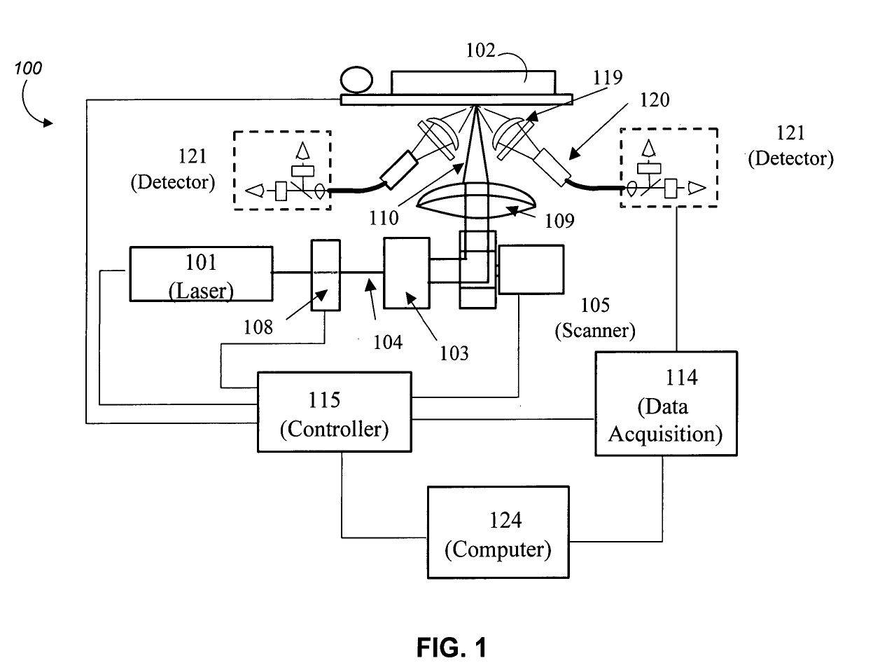

FIG. 1 shows one embodiment of the apparatus. As shown in FIG. 1, an excitation light source (101) emits excitation light (104) to be projected onto a substrate (102) containing samples that are to be investigated. The substrate (102) will be described in further detail below. Typically, the excitation light source (101) is a laser, such as an Ar or Ar/Kr mixed gas laser with excitation lines of 488, 514, 568 and 647 nm. In one embodiment, a continuous wave (CW) laser, such as the Compass 315 M laser from Spectraphysics Inc. of Mountain View, Calif., is used as an excitation source. Depending on the laser (101) and specific optics used in the apparatus, the wavelength of the excitation light can be either within the visible range (i.e., 400-700 nm), or outside the visible range. For excitation wavelengths below 400 nm photochemical reaction rates, such as those due to photobleaching, tend to be substantial. In one embodiment, the output from the laser (101) can be modulated and provide information about the time dependent response of fluorescence signals by using a frequency modulation detection scheme. In another embodiment, a pulsed laser with laser pulses of approximately 12 ps FWHM (Full Width at Half Max) with a spacing of approximately 12 ns is used as the excitation light source (101). The average power of the laser (101) at the samples on the substrate (102) is typically in the range 1 mW-1 W. The spacing of 12 ns is convenient for fluorescent lifetime detection, but can be varied as necessary, for example, by varying the cavity length of the laser (101). Common to both embodiments is the use of time-resolved imaging as a contrast-producing agent.

After leaving the laser (101), the excitation light (104) passes through one or more illumination optical elements to the substrate (102). The illumination optical elements can include an electro-optic modulator (108), a set of beam-shaping lenses (103), a scanning device (105), and a multi-element lens (109). The electro-optic modulator (108) can be used to modulate the polarization of the excitation light (104), if required by the investigation that is to be carried out on the samples on the substrate (102). The set of beam-shaping lenses (103) expands the laser beam in order to match the input aperture of the scanning lens and provide the desired illumination region size at the sample wells on the substrate (102). The scanning device (105) moves the expanded laser beam back and forth in a line-scan over the substrate (102) after the beam has been focused by the multi-element lens (109). The scanning device (105) can be an electromechanical device coupled to an optic element, such as a mirror driven by a galvanometer. In one embodiment, the scanning device (105) uses a polygon with multiple reflective surfaces to scan the laser beam across the substrate (102).

The multi-element lens (109) is designed to focus the laser light at the operating wavelength of the laser (101). The multi-element lens (109) can, for example, be a microscope objective designed for the operating wavelength or a specially designed scanning lens, such as a telecentric lens, that has appropriate parameters to achieve a flat focal plane, for example, with a long working distance and low first and second order aberrations, thus producing the same spot size and shape over a wide range of positions (such as a scan line). The telecentric lens is particularly useful for covering a large field of view. After passing the multi-element lens (109), the beam (110) is focused onto a region of the substrate (102) containing a sample to be imaged. The samples on the substrate (102) can be, for example, liquids, spots, beads, or cells that are to be interrogated by fluorescence.

The fluorescent light emitted by the samples is collected by one or more collection optical elements (119). There are several ways to configure the collection optical elements (119) that allow scanning of a large array of samples on a substrate. In one embodiment, the collection optical elements (119) is a rod lens, designed to capture the entire range of sweep of the beam (110) over one dimension of the substrate (102). The collection optical elements (119) can also include other types of lenses, or an aggregate of lenses, as would be determined by the specific information required from the emission. In some embodiments, multiple setups of collection optical elements (119) can be used to improve collection efficiency.

The light collected by the collection optical elements (119) is transmitted to a detector (121) located at a convenient distance from the collection optical elements (119). The transmission of the fluorescent light can be accomplished by, for example, an optical fiber or a bundle of optical fibers (120). In one embodiment, the detector (121) is a detector with high gain, such as a photomultiplier tube, which produces an electrical output signal. The electrical output signal is further processed by a data acquisition system (114), connected to a computer (124) which performs operations such as optimization of the gain and the signal to noise ratio (S/N), by making use of signal enhancing, averaging, or integrating detection systems.

The apparatus is typically implemented to include digital electronic circuitry, or computer hardware, firmware, software, or combinations of them, for example, in the controller (115), data acquisition system (114) and computer (124). Such features are commonly employed to control use of the substrates (both to deliver samples and interrogate samples disposed in the wells of the substrate). Apparatus of the invention can be implemented to include a computer program product tangibly embodied in a machine-readable storage device for execution by a programmable processor; and method steps of the invention can be performed by a programmable processor executing a program of instructions to perform functions of the invention by operating on input data and generating output. The processor optionally can be coupled to a computer or telecommunications network, for example, an Internet network, or an intranet network, using a network connection, through which the processor can receive information from the network, or might output information to the network in the course of performing the method steps.

The Substrate

The substrate (102) in accordance with the invention is designed to allow a high density of samples to be interrogated by a continuous wave, pulsed, or modulated scanning device, such as the apparatus discussed above. The substrate (102) is designed with features that allow the admittance, localization, containment and analysis of the transferred samples. The samples are contained in sample wells on the substrate (102), which are either identified by a format, or an identifier on the substrate surface, such as a track mark that allows each sample well location to be mapped, and therefore be located by an inspection system.

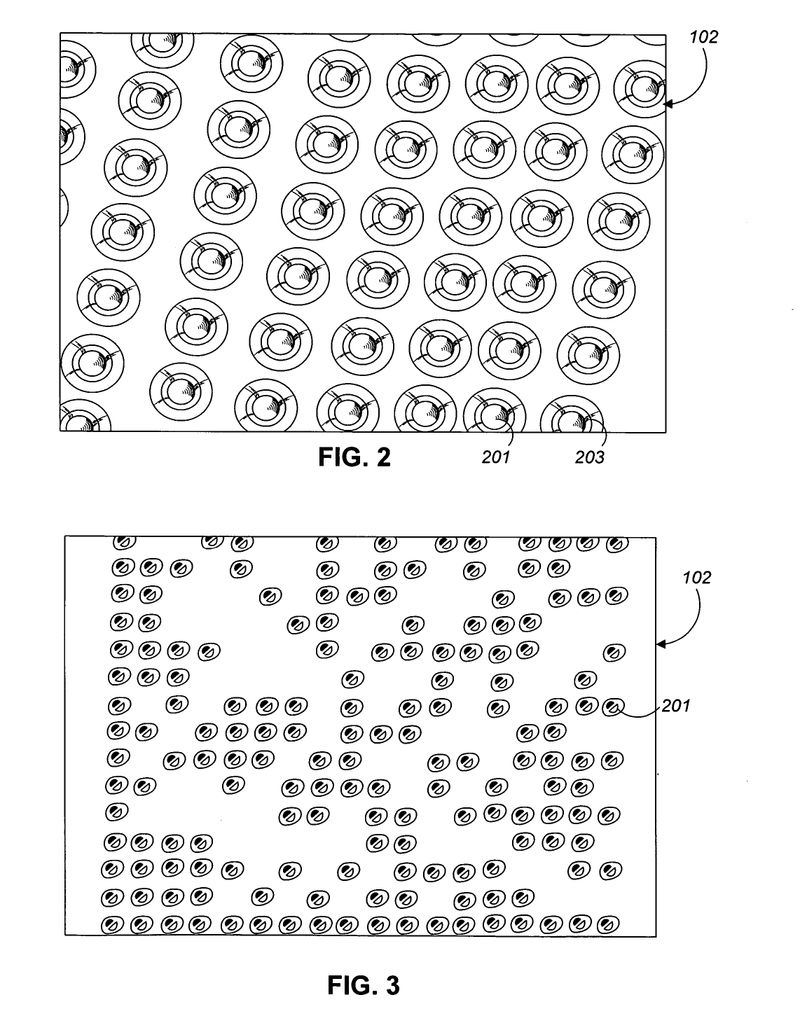

FIG. 2 is an aerial view of a section of a substrate (102) containing multiple sample wells (201). In one embodiment the substrate (102) is transparent in the visible range of the electromagnetic spectrum and possibly beyond to portions of the infrared and/or ultra-violet ranges as well. In a specific example, the substrate can admit light in a wavelength region of approximately 300 nm-1100 nm, thereby allowing the sample wells (201) to be examined from the bottom of the substrate (102) by the apparatus. In other embodiments, which will be discussed in further detail below, the substrate (102) is made of metal or some other non-transparent material and is interrogated from the top.

In one embodiment, the transparent substrate (102) is made of glass, for example, a borosilicate glass or an alumina-silicate glass. Both of these glass types have very low attenuation coefficients for light in the wavelength of 300 nm-1100 nm that may be used for optical interrogation of the samples in the sample wells (201), which makes the glass types suitable for optical applications. These glass types are also dimensionally stable, which allows the sample wells (201) to retain their original shapes and locations even if the substrate were to be subjected to moderate temperature changes, as may be required by the different assays performed in the sample wells (201).

Other glasses may be employed, as well as certain metals, ceramics, and polymeric materials. For many applications, rigid, relatively hard materials are preferred. In one example, aluminum is employed, with an optional coating of a nickel-phosphorus (NiP) alloy formed by, e.g., electroplating an aluminum plate. In a specific example, the wells can be formed directly in the NiP coating. Other materials of construction may be employed such as dimensionally stable polymers; e.g., some polycarbonates. It should be noted the substrate may be a monolithic material (e.g., borosilicate glass or aluminum) or a layered structure such as aluminum with a coating of nickel-phosphorus alloy. In another example, a layered structure comprises glass substrate with a hydrophobic polymer coating (e.g., a fluorinated polyolefin). Hydrophillic wells may be defined by gaps in the hydrophobic coating. In yet another example, the substrate is manufactured from a plastic, such as a thermoset plastic, a polyamine, or a polycarbonate.

The mechanical properties of the borosilicate glass and the alumina-silicate glass also makes it possible to manufacture a substrate (102) at great precision with respect to the flatness of the substrate. Other glass, metal, and ceramic materials may also be manufactured to provide substrates of sufficient flatness. The manufacturing process for the substrates (102) will be discussed below in a separate section. In some embodiments, a substrate (102) in accordance with the invention has a flatness corresponding to only a few micrometers variation across the substrate (102), which typically extends several centimeters in the horizontal plane. The flatness of the substrate (102) is important, since it allows the scanning control system to easily maintain the focal point of the collection optics of the apparatus within the sample wells (201). As a result, there is no need to refocus the collection optics for each sample well, and the analysis of the sample wells can thus be faster, resulting in a higher throughput. In addition to the flatness, the substrate surface can be polished during the manufacturing process to have a very low roughness, typically in the range of a few Angstroms. The roughness of the surface is an important factor in successfully collecting the light from the samples, because a smooth surface results in less scattering and distortion and thereby a more accurate data collection of light emitted from the samples. Substrates having roughness and flatness on the scales mentioned here are easily attained using chemical and/or mechanical polishing and similar techniques currently deployed in hard disk drive manufacturing.

Different embodiments of the substrate (102) can have different shapes. In one embodiment, the substrate (102) is rectangular and the sample wells (201) are arranged in rows and columns on the substrate (102), although other arrangements are possible such as circumferential (e.g., evenly separated wells along a circular or spiral path), radial, non-perpendicular rows and columns, and the like. Any such arrangement of wells on the substrate (102) allows the sample wells (201) to be illuminated and interrogated by a line scanning device, such as the one described above. In order for the apparatus to know where to begin the scanning and to know in which direction to scan the substrate (102), a set of reference marks or fiducials may be provided on the substrate (102). By locating the fiducials and knowing the distance between the different sample wells (201) and the size of the substrate (102) (or the number of wells in a scan line), the apparatus can determine the location of each sample well (201) on the substrate and correlate the optical response from the sample in the sample well (201) with the location and/or the sample material in the sample well (201). In a typical substrate and associated imaging system, very little separation distance will be required between individual wells is necessary, e.g., about 50 to 500 micrometers separation between centers of adjacent wells and more preferably about 50 to 200 micrometers separation. In one embodiment the wells are arranged on the substrate in a standard pattern, as defined by the Society of Biomolecular Screening (SBS), and in a format with outer dimensions also defined by SBS for robotic handling of the substrate.

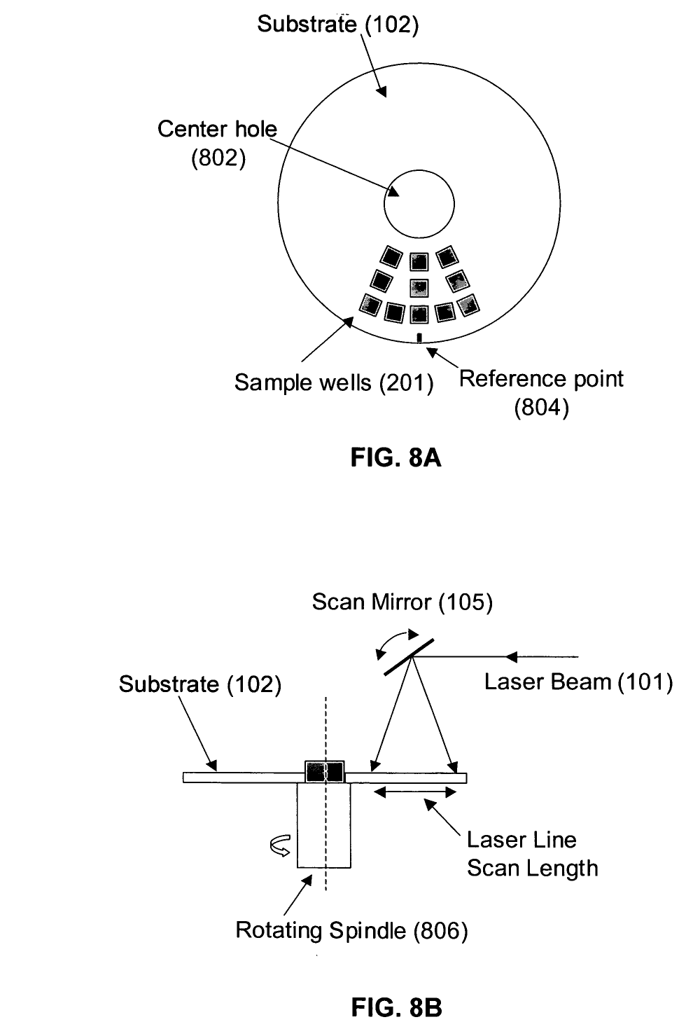

In another embodiment, shown in FIG. 8A, the substrate (102) is circular, and the sample wells (201) may be arranged in radial lines extending from the center of the substrate (102) to the perimeter of the substrate (102). It should however be noted that it is not a requirement for the sample wells (201) to be located at specific radial distances from the center of the substrate (102), or to have uniform angular spacing on the substrate (102). This embodiment of the substrate (102) also allows the sample wells (201) to be illuminated and interrogated by a line-scanning device (100) while the substrate (102) rotates, as can be seen in FIG. 8B. In a specific embodiment, a circular glass substrate as employed in magnetic storage media is used as the substrate. Such substrates, with micrometer level flatness and angstrom level roughness are readily available and inexpensive. One example of such a substrate is the 65 mm N5 disk substrate, manufactured by Hoya Corporation of Tokyo, Japan. Generally, only an angular reference point (804) is needed in order to identify the locations of the sample wells (201), since the center hole (802) of the substrate (102) forms a natural reference point in the radial direction. It provides other advantages as well, such as allowing a complete interrogation of every well, at every radial and angular position, without needing to stop and start the rotational movement of the substrate with respect to the source light beam. The substrate (102) can be rotated at an even velocity and no acceleration or deceleration is necessary, except for at the beginning and the end of the scanning of the samples. Thus, rotating circular substrates are particularly useful for repetitive examination of the same samples, such as kinetic studies. The circular nature of the substrate also makes it possible to move the samples contained in the sample wells (201) in and out of heating and cooling zones, respectively, which is useful in, for example, PCR (Polymerase Chain Reaction). It should be noted that the applications given herein are merely examples of various uses of the substrate and the apparatus and that a person skilled in the art would be capable of coming up with many variations and similar applications that would be equally suitable for the apparatus, substrates, and methods described herein.

FIG. 3 shows yet another embodiment of the substrate (102), wherein the arrangement of sample wells (201) on the substrate (102) provides encoding information. For example, the locations of the sample wells (201), define a barcode uniquely identifying the substrate (102) and the samples deposited on the substrate (102). The embodiment shown in FIG. 3 complies with the Data Matrix code signature in accordance with ISO/IEC 16022. The apparatus detects the presence of individual wells, determines their arrangement with respect to one another and makes a determination of the substrate type and/or experimental information employed for the individual wells. This allows the system to store acquired data in specific physical and/or logical storage locations reserved for the substrate and individual wells. The pattern of the sample wells can also allow the sample type to be identified, and eliminates the need of keeping track of what samples are dispensed into what sample wells. Similarly, the pattern of the sample wells can also allow encoding information for measuring a particular target, such that the analyzing system or apparatus knows which types of measurements to perform in a given set of sample wells.

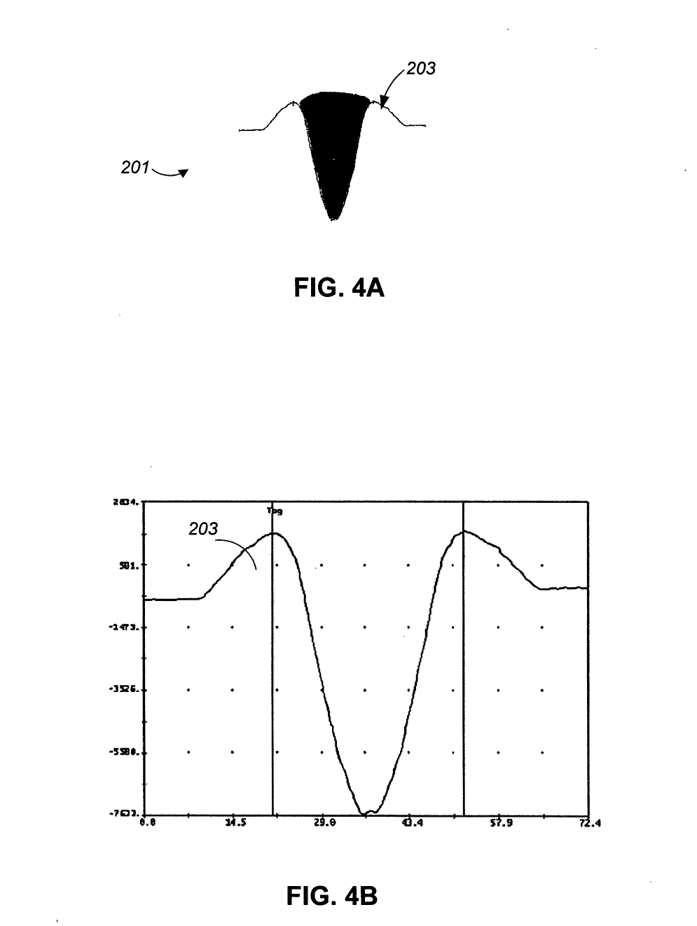

FIGS. 4A and 4B show a vertical cross-section of a single sample well (201). It should be noted that the horizontal and vertical scales of FIGS. 4A and 4B are different. Typically, the aspect ratio of the width of the sample well (201) to the depth of the sample well (201) is in the range of about 100:1 up to about 10:1, that is, the wells are much wider than deep. Typical diameters (or more generally principal dimensions) of the sample wells are in the range of about 1-100 micrometers (more preferably about 10-30 micrometers), and their depths are typically in the range of about 10 nanometers to 10 micrometers (more preferably about 100 nanometers to 5 micrometers). In the illustrated embodiment, the sample wells (201) have a circular shape with slightly slanted walls. This minimizes the risk of bubble trapping within the sample wells, which potentially could interfere with the optical probing of the samples in the sample wells (201) and reduce the quality of the received signal from the sample wells (201). It should however be realized that other shapes of sample wells are possible too. For example, the sample wells may have a perimeter that is rectangular or square, and/or have straight, vertical sidewalls.

Regardless of the perimeter shape and diameter/depth aspect ratio, the total volume of an individual well is preferably in the range of about a nanoliter or smaller. In a more limited embodiment, the volume range of the individual wells is between about 1 and 100 picoliters. In some cases, the well volume is even in the sub-picoliter range. Attaining consistent dimensions and well volumes is achievable using substrates and manufacturing techniques described herein. The shallow depths and relatively small diameters of the wells roughly conform with the focal region of an interrogating laser beam. Hence the “reading” taken from a sample well typically represents an average value over the entire sample or a substantial portion of the entire sample. As was discussed above, the flatness of the substrate also facilitates keeping the sample in the focus region of the collection optical elements. Note that many cells have a volume of approximately one picoliter, with some larger and others smaller. Hence, the wells can be sized to hold individual cells from animal or human donors, as well as of particular cell lines.

As can be seen in FIGS. 2 through 4B, the perimeter of the sample wells (201) in one embodiment of the substrate (102) is surrounded by a lip (203) that extends above the surface of the substrate (102). The lip (203) prevents samples contained in the different sample wells (201) to be mixed with each other, which is also referred to as “cross-talk” between the sample wells. Typically the height of the lip (203) above the substrate's top surface is about one-tenth to about one-third of the depth of the sample well (201) (e.g., about one-fifth of the depth), but the height of the lip (203) can be varied beyond this range as needed during the manufacturing process of the substrate (102), depending on the applications for which the substrate (102) is to be used.

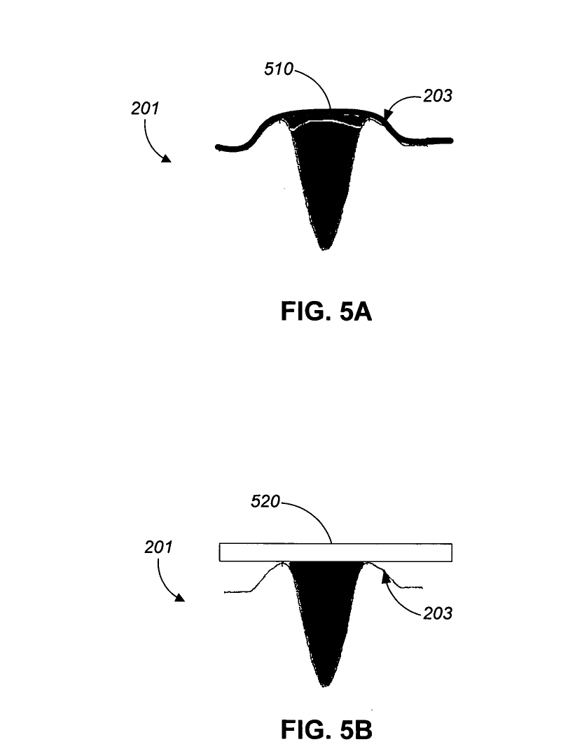

In order to further prevent overflow of the sample wells (201), a substrate cover can be applied to the substrate after the samples have been applied, as shown in FIGS. 5A and 5B, which will be described in further detail below. The substrate cover can come in one of many forms, for example, as another piece of glass that has been manufactured using the same polishing techniques that were used to manufacture the substrate. Due to the well-defined flatness of the two glass pieces, a tight seal can be created over the sample wells (201), such that no sample portions can leak out through the sample wells (201). Other types of substrate covers, such as mineral oils, perfluorinated polyethers, glycerol, various adhesive tapes, polymers, and so on, can also be used and will be described in further detail in the following section.

Delivering Samples and Sealing Substrate

As was discussed above, various reactions can be performed in the sample wells (201) on the substrate (102), for example, chemical or biochemical reactions, such as a bioassay. This section describes by way of example how samples are applied to and contained in the sample wells (201) on the substrate during interrogation.

First, a sample is applied to a sample well (201) by any one of a variety of methods for transfer small volumes of material reliably and reproducibly, including contact and non-contact techniques. For this purpose, the apparatus may employ a dispensing tool, such as a micropipette, e.g., the Innovadyne Nanofill™ dispense tool, manufactured by Innovadyne Technologies of Santa Rosa, Calif., a pin tool such as the Microquill from Parallel Synthesis Technologies Inc. of Santa Clara, Calif., or a non-contact dispense tool, such as an Echo 550 dispense tool, manufactured by Labcyte Inc. of Sunnyvale, Calif. Pin tools deliver samples to wells on a substrate by dipping pin tips in a reservoir and spotting on the wells by contact. Capillary force may draw the sample from the pin tip to the well. Some pin tools are provided as rectangular grids that can spot to an array of wells simultaneously. Non-contact dispense tools can employ, for example, an acoustic wave to deliver the sample without having the tool actually contact the substrate surface. In some cases, it may be appropriate to spray or dip or otherwise contact the entire substrate, or a portion thereof, with sample solution. The solution may contain a biological target protein or other sample. Each well will contain essentially the same quantity of sample. Different compounds or concentrations of a compound can be applied to each separate well. In a related approach, the entire substrate or a portion thereof is contacted with a solution of a compound under investigation. Individual wells are contacted with separate cells, cell lines or other biological material.

As was discussed above, the sample is contained in the sample wells (201) because of various physical forces, such as gravity, capillary action, and surface tension, acting alone or together in various combinations, respectively, and because of the nature of the volatility of the components of the sample, as for example the solvent. In an example discussed below, water is the solvent. With water and similar media, since the volume of the sample is very small, the sample needs to be constrained by some means from evaporating from the sample wells (201), such as a cover. There are many different types of covers that are suitable for containing the samples in the sample wells (201). Some of them are listed below.

In one embodiment, the sample material in the sample well (201) is amenable to application of another liquid, for example, a silicone polymeric resin. The resin is applied directly to the bead and binding reagent sample with a dispense system of the same type that is used to apply the sample and the reagent. The amount of resin applied to the target sample is typically in the range of about 10 picoliters to 50 microliters, and just like the sample and the reagent, the resin can be applied with the substrate (102) oriented in any position. When the resin is applied, it enters the sample well (201) so that the resin contacts the sample in the sample well (201). For a water based solvent, such as in the above example, the resin remain on the outer surface of the sample, since the resin is immiscible with the solvent. In another embodiment, the resin mixes with the sample, but retains its ability to polymerize, such that the polymer forms a matrix for the sample and does not allow the sample to evaporate. Other liquids suitable for use as a cover (510) include mineral oils, polyethers, and glycerol, for example. FIG. 5A shows a polymeric cover (510) only covering the sample well (201). However, it should be realized that the coating (510) can cover the entire surface of the substrate (102) and accomplish the containment required.

In another embodiment, the cover is supplied by a thin film laminate, which is contacted with the surface of the substrate (102) subsequent to the application of the sample and binding reagent. The contact is made by feeding the substrate (102) and the laminate, in this case a silicone rubber sheet or film, through a roller assembly, which brings the silicon film in contact with the lips (203) of the sample wells (201) because they extend above the surface level of the substrate (102) as described above. The lips (203) effectively prevent the samples from escaping by evaporation because the samples have a limited area for the liquid to escape.

In yet another embodiment, the cover is supplied by spray coating a resin over the substrate surface. The coating then forms a thin film polymeric coating that prevents evaporation from the sample wells (201). In another embodiment, the cover is supplied by another smooth rigid transparent substrate (520), such as plastic or glass, which contacts the surface of the substrate (102) so as to prevent evaporation of the sample, as depicted in FIG. 5B. Given the flatness with which the glass substrates (102) can be manufactured, this typically provides a very good seal for the sample wells (201) and successfully prevents evaporation of the contents of the sample wells (201). In one example, glass with micrometer scale flatness produced by chemical mechanical polishing is used as the cover. The substrate with wells and the cover may both be disks of the approximately (or exactly) the same diameter. In one embodiment, the outside edge of the substrate and the cover is sealed to prevent escape of sample liquid and to prevent the cover from slipping from the substrate.

In a specific example, the sample is biotinylated 4 micrometer microbeads, suspended in a buffered water solution. After the sample has been applied to the substrate (102), the sample well (201) contains a sample of beads in a buffered solution of water. The size of the sample in this example is in the range from about 10 picoliters to 5 nanoliters. Furthermore, the sample can be applied to the substrate (102) with the substrate (102) oriented in any position, that is, the openings of the sample wells (201) can be facing upwards, downwards, or any intermediate angle. In this particular example, the sample wells are oriented with their openings facing downwards. The sample is applied with a non-contact dispensing apparatus, such as an acoustic dispense apparatus, directing a droplet of sample upward, entering the sample wells (201) so that the sample sticks to the substrate (102) by virtue of surface energies, and remains inside the sample well.

After the sample has been applied to the sample well (201), a fluorescent stain or tagged fluorescent material, which is to interact with the sample material, is applied. In this example, the fluorescent material is in the form of a binding reagent that binds to the beads that are present in the sample wells (201). The binding reagent can be, for example, a Streptavidin-Alexa Fluor® dye from Molecular Probes Inc. of Carlsbad, Calif., and is applied directly to the bead sample with a liquid dispense apparatus, such an Innovadyne Nanofill™, or a non-contact dispense system such as the Echo 550 dispense tool. The amount of binding reagent applied to the target sample is typically in the range of approximately 10 picoliters to 5 nanoliters, and just like the sample, it can be applied with the substrate (102) oriented in any position. Again, in this example the sample wells are oriented with the openings of the sample wells (201) facing downward. The fluorescent material is applied with an acoustic dispense apparatus directing said amount of reagent upward into the sample wells (201) so that when the binding reagent contacts the sample in the sample well (201), it enters the sample solution and becomes part of the sample. The sample remains on the substrate (102) by virtue of surface energies, and although the sample well's opening is oriented downward in this example, the sample and reagent will remain inside the sample wells (201). As indicated above, other methods of applying the samples or reagent include using pin tools or spotting tools, and spraying or dipping the whole substrate into a sample or reagent (provided that the same sample or reagent should be applied to all the sample wells).

Interrogating the Samples on the Substrate

After dispensing the samples into the sample wells (201) on the substrate (102) and potentially sealing the substrate, as described above, the samples can be optically interrogated, for example by an apparatus such as the one described in the above referenced copending patent applications. Fluorescence signals can be collected that may also include time dependent spectral information. The methods and apparatus of the invention make it possible to measure, for example, fluorescence intensity, fluorescence spectral color, fluorescence lifetime, background fluorescence intensity, fluorescent polarization and/or anisotropy and the ratios of any of these values. Generally, the fluorescence signal is obtained by applying a light source, such as a laser, to the sample well (201) under interrogation in the substrate (102), which causes the sample to fluoresce—either by autofluorescence, or by previously having been marked with a molecule or probe, that can be stimulated to fluoresce. The signal from the sample well (201) contains information such as bulk fluorescence intensity, color, lifetime, polarization, as well as information about any objects in the sample well (201), for example, the number of discrete positions in a sample well (201) or other objects from which the light signals originate, the relative location of the signal sources, and fluorescence information emitted at each position in the object.

It should be understood that the invention is not limited to detecting fluorescent response. In some systems, the optical signal will be wholly or partially non-fluorescent. Some interrogation systems will interrogate the sample using, for example, reflectance, polarization, ellipsometry, and the like to determine how a surface has been impacted by binding of bio-molecules.

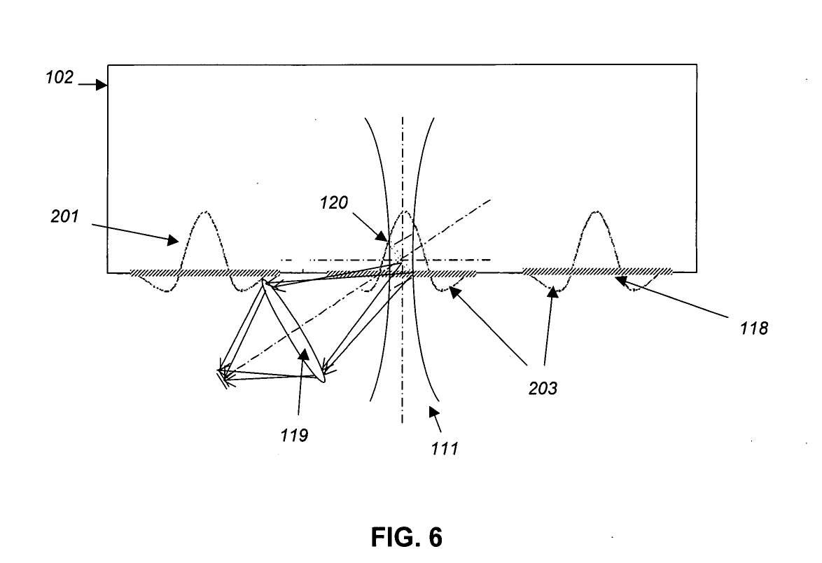

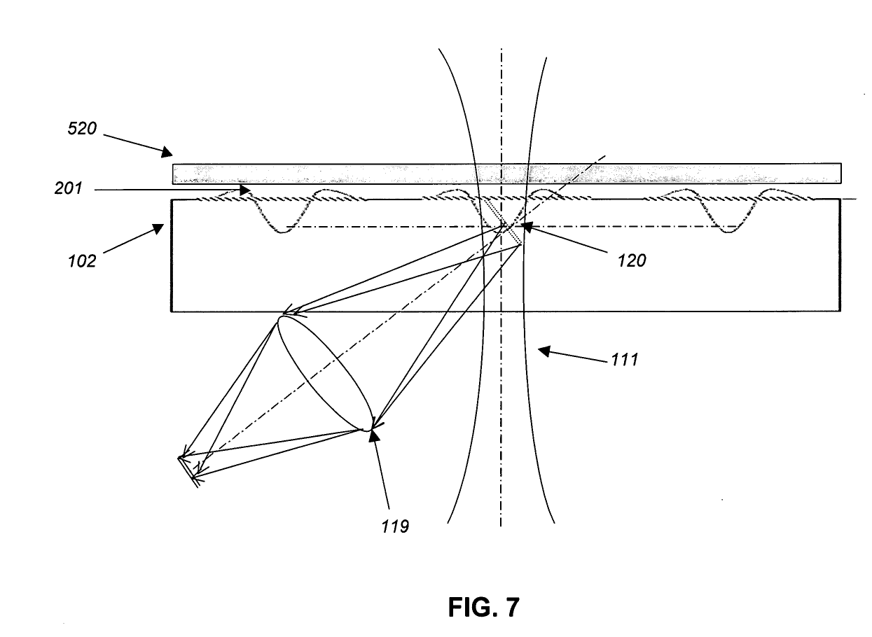

FIGS. 6 and 7 show a schematic view of a substrate (102) with multiple sample wells (201) and part of the collection optical elements (119) of an apparatus for collecting optical data from the samples. It should be noted that in both FIGS. 6 and 7 the substrate (102) and the collection optical elements (119) have not been drawn to scale, in order to more clearly show the principles of the invention. In FIG. 6, the openings of the sample wells (201) face downwards, and in FIG. 7 the openings of the sample wells (201) face upwards and a solid cover (520) is applied to prevent evaporation of the sample, as discussed above. In both cases, the collection optical elements (119) are placed below the substrate (102). The focal region (120) of the collection optical elements (119) is confined to a region within the sample well (201) as shown in FIGS. 6 and 7, thereby eliminating the need to have a device which must continuously adjust the focus in real time over an array of sample wells (201), as was discussed above. Further details about the illumination region (111) and the focal region (120) can be found in the above referenced copending patent applications. For many applications, a laser spot of about 5 to 10 micrometers is employed. This allows the entire well (or nearly the entire well) to be illuminated at once by the laser. Preferably, the incident laser operates in a power range of about 1-100 mW, e.g., about 20 mW.

The samples can be retested for activity at multiple times, for example, after a certain time period subsequent to containment with the cover (520). Depending on the type of investigation, the substrate (102) can be kept at a particular temperature, as may be required when an assay is performed, or can be cycled in temperature from a high and low temperature over time. The sample can then be re-interrogated as described above. When a circular substrate (102) is used the substrate can be moved through the interrogation apparatus, for example, using a rotating spindle for a drive mechanism, analogous to a compact disc or hard disk drive. The circular drive mechanism can be used to both apply the sample and reagents to the wells, and to analyze the sample subsequent to the dispensing of the samples and/or reagents. FIG. 8B shows one embodiment of a circular substrate (102) that is moved through one embodiment of the interrogation apparatus (100), using a rotating spindle (806) for a drive mechanism and being scanned along a radial line with a laser beam (101). Samples and reagents can be applied to the wells by a dispense mechanism (not shown), which can be located, for example, across the rotating spindle (806) from where the laser scan occurs.

As indicated above, lips on the edges of the wells, or other features put on the substrate surface, can be employed to identify the locations of individual wells to facilitate data acquisition. Often it is desirable to limit the quantity of data being acquired, processed, and/or stored. To this end, the system may identify when a scanning source beam approaches a well and only then begin acquiring data for processing and/or storage. In one example, the surface deflection of an incident beam is monitored to determine when it encounters the lip of a well. Thereafter, the relevant optical signal is acquired, when beam is centered in the well. In some system designs, one channel is reserved for detecting incident beam deflection at the lip and another channel is used for observing signal.

Many types of investigations can be performed on the sample in the sample wells. For example, a plane polarized laser beam can be propagated through the optical system onto the sample, allowing interrogation of the sample with polarized light. The emitted light from the sample can be separated into its two orthogonal polarization components and analyzed either sequentially in time with a switchable modulator, such as an electrooptic modulator, to allow for detection of the parallel and perpendicular components, or simultaneously with multiple collection optics with specified perpendicular and parallel polarizing filters. The polarized nature of the excitation source allows for measurement of properties of biological materials where the characteristics of the anisotropy of the emission, or rotational correlation time, can give rise to spatial or physical information about the biological moiety. Another example is to propagate several laser beams through the optical system onto the sample allowing interrogation of the sample with different wavelengths of light or with the same wavelength at different times. In this mode the lasers can be pulsed simultaneously or with some fixed or variable delay between pulses. Regardless of the type of interrogation that is performed, a very high signal discrimination from background fluorescence in the sample well can be achieved due to the small volume of the sample. Furthermore there is no need for spatially filtering the fluorescent signal, as is typically the case with a conventional confocal microscopy setup. Many other types of sample interrogations are possible, some of which are described in further detail in the above referenced patent applications.

Substrate Manufacturing

A glass substrate (102) as described above can be manufactured by polishing a piece of borosilicate or alumina-silicate until it becomes planar to within a few tens of micrometers over an area of about 75 millimeters by 110 millimeters, in the case of a rectangular substrate (102), or over a circular area having a radius of about 100 millimeters in the case of a circular substrate (102). In both embodiments, the substrate (102) can be made approximately 0.5 millimeters to 50.0 millimeters thick. Suitable polishing techniques are similar to those used for polishing semiconductor wafers in the semiconductor industry, such as chemical mechanical polishing (CMP), or polishing of glass substrates by slurry processes that are also employed for magnetic recording media.

After a flat glass substrate (102) has been obtained, the sample wells (201) are formed in the glass by a suitable process. Such processes should not produce debris or introduce cracks in the substrate. They should also produce wells of consistent dimensions quickly and inexpensively. On suitable method employs a glass zone laser texture (GLZT) technique. In one embodiment, a pulsed continuous wave or a modulated carbon dioxide laser is used. In embodiments employing NiP alloy, the wells can be formed using a solid-state neodymium vanadate laser. The thermal cycle imposed by the laser pulse results in the formation of a shallow sample well (201) and a lip (203) near the surface of the glass. Currently, a high-volume, automated method for making substrates (102) can accommodate any form factor with a throughput of more 250 substrates per hour, and average well edge or lip height process standard deviation of less than one nanometer. Typically, the glass substrates are manufactured by forming disk blanks, cutting the center hole, grinding the edges, and then polishing the surface using a slurry, such a cerium oxide slurry, and polishing pads. Such techniques are currently employed in the disk drive manufacturing and laser marking fields and the technology is well evolved. SpeedFam of Des Plaines, Ill., is an example of a company that manufactures a polishing tool suitable for the final substrate polishing process.

Other methods of forming the well within a substrate (102) can also be used. For example, a thick substrate of glass, metal, ceramic, or plastic material is can be used and a deformable layer, typically a thick polymeric material, can be applied to the substrate (102). The polymer can be applied any number of ways, such as spinning it on, laminating it, spray coating it, or by any other means known to those skilled in the art. A stamp can then be applied to the polymer coating to deform the polymeric layer and form the sample wells (201). The well shape will depend on the size, shape, density, and material of the film layer in the substrate, and on the stamp used to form the wells, and can be fabricated to meet the requirements of the apparatus used for analyzing the samples contained in the sample wells (201) on the substrate (102). Other techniques for introducing wells include lithography techniques employing masking and plasma etching, direct e-beam writing, micromachining, and the like.

In a specific example, the substrate is prepared using the following sequence of operations: (a) provide a flat clean sterile glass substrate, (b) provide a biological surface modification to the substrate (e.g., streptavidin or poly-L-lysine), (c) preclean the glass surface, (d) place the substrate in a laser marking tool, and (e) sequentially move the laser with respect to the substrate to introduce the wells.

### Other Embodiments

The present invention enables many applications, such as those described above, but the invention is not necessarily limited to these applications. For high sensitivity fluorescence imaging of live cells, assays can be carried out concerning cell cycles or phases, such as assays of cell differentiation, transformation and senescence. For each cell type a full portfolio both of physiopathological events and drug responses can be collected, both at the molecular level and at the subcellular organelle level. Responses due to therapeutic drug action can be determined, such as drug distribution within cells and subsequent cell detoxification, chemical distributional changes within a cell. Micro-spectrofluorometry that uses either endogenous or engineered probes, can be used to determine cellular and/or subcellular activity. Among the parameters to be considered in an experimental design are chemical structure, concentration of a given chemical compound, cell line response, protein array response, antibody array response, transcription profiles, and the like.

A number of implementations of the invention have been described. Nevertheless, it will be understood that various modifications may be made without departing from the spirit and scope of the invention. For example, while a continuous scanning mode of interrogating the individual samples has been described, other techniques such as a parallel illumination or stepping may be employed. The above description has been focused on biological applications, but the apparatus and methods described above can also be used to detect non-organic substances in air or liquids. Accordingly, other embodiments are within the scope of the following claims.

1. An apparatus for collecting optical data pertaining to one or more characteristics of one or more samples, the apparatus comprising:
a light source;
a flat substrate having formed therein a plurality of sample wells, each sample well being configured to hold a sample volume of no more than about 50 nanoliters;
one or more illumination optical elements for directing a light beam from the light source onto the sample wells;
one or more collection optical elements for collecting light originating from within the sample wells and transmitting the collected light to one or more detectors.

2. The apparatus of claim 1, wherein each sample well is configured to hold a sample volume no greater than about 10 nanoliters.

3. The apparatus of claim 1, wherein each sample well is configured to hold a sample volume no greater than about one nanoliter.

4. The apparatus of claim 1, wherein the substrate further includes a substrate cover that seals edges of the individual sample wells.

5. The apparatus of claim 1, wherein the substrate has a substantially circular shape.

6. The apparatus of claim 5, wherein the substrate has a hole in the center of the substrate, allowing the substrate to be placed on a rotating spindle.

7. The apparatus of claim 6, wherein the circular substrate further comprises a reference mark for referencing all sample well locations on the substrate.

8. The apparatus of claim 1, wherein the substrate is a glass substrate.

9. The apparatus of claim 1, wherein a perimeter of a sample well is substantially circular and the diameter of the sample well is significantly larger than a depth of the sample well.

10. The apparatus of claim 9, wherein the diameter of a sample well is in the range of 1-100 micrometers.

11. The apparatus of claim 1, wherein the depth of a sample well is in the range of 10 nanometers to 10 micrometers.

12. The apparatus of claim 1, wherein a perimeter of each sample well is surrounded by a lip for preventing overflow of the sample well and cross talk between the sample wells.

13. The apparatus of claim 12, wherein the lip extends to a height corresponding to about one-tenth to one-third of the depth of the respective sample wells.

14. The apparatus of claim 1, wherein each sample well contains a sample that is unique with respect to the samples in the other sample wells on the substrate.

15. The apparatus of claim 1, wherein the sample contained in a sample well comprises at least one of: a biological sample and material derived from a biological sample.

16. The apparatus of claim 1, wherein the centers of the sample wells are separated by no more than 100 micrometers.

17. The apparatus of claim 1, wherein the substrate has a surface height variation of not more than about 10 micrometers over a region of the substrate that is readable by the apparatus, and wherein the region that is readable by the apparatus has a roughness of not more than about 10 nanometers.

18. The apparatus of claim 1, wherein the substrate areas between the sample wells are coated with a hydrophobic material and the sample wells are hydrophilic.

19. A method for collecting optical data pertaining to one or more characteristics of one or more samples, comprising:
providing a flat substrate having formed therein a plurality of sample wells, each sample well being configured to hold a sample volume of no more than about 50 nanoliters;
dispensing one or more samples into the plurality of sample wells;
directing a light beam from a light source onto the sample wells;
collecting light originating from within the sample wells and transmitting the collected light to one or more detectors; and
analyzing the signal from the detectors to detect the one or more characteristics of the one or more samples.

20. The method of claim 19, wherein each sample well is configured to hold a sample volume smaller than 10 nanoliters.

21. The method of claim 19, wherein each sample well is configured to hold a sample volume smaller than one nanoliter.

22. The method of claim 19, wherein a perimeter of each sample well is surrounded by a lip for preventing overflow of the sample well and cross talk between the sample wells, and wherein collecting light comprises:
detecting when a focal point of a set of collection optical elements passes across an identifying feature on the substrate; and
collecting light only when a focal point of a set of collection optical elements is located inside the perimeter defined by the lip.

23. The method of claim 22, wherein the identifying feature on the substrate is a lip surrounding a sample well.

24. The method of claim 19, wherein the substrate is substantially circular and wherein collecting light comprises:
rotating the circular substrate past a set of collection optical elements; and
collecting light originating from within the sample well periodically each time the sample well rotates past the collection optical elements.

25. The method of claim 24, wherein the substrate has a hole in the center of the substrate and rotating comprises:
rotating the circular substrate by means of a rotating spindle placed through the hole in the center of the substrate, past a set of collection optical elements.

26. The method of claim 19, wherein the substrate areas between the sample wells are coated with a hydrophobic material and the sample wells are hydrophilic.

27. A substrate for holding one or more biological samples in an apparatus for collecting optical data pertaining to one or more characteristics of the biological samples, the substrate comprising:
a flat transparent glass substrate having formed therein a plurality of sample wells and a set of fiducials against which the location of the sample wells can be determined by the apparatus,
wherein each sample well holds a volume of a biological sample of no more than about 50 nanoliters by one or more of: gravity, capillary action and surface tension,
wherein each sample well is surrounded by a lip arranged to prevent cross talk between the sample wells,
wherein the substrate areas between the sample wells are coated with a hydrophobic material and the sample wells are hydrophilic; and
a substrate cover that seals edges of the individual sample wells.
